(19) United States
(12) Patent Application Publication
(10) Pub. No.: US 2013/0134629 A1
(43) Pub. Date: May 30, 2013

(54) EMBOSSING METHOD AND EMBOSSING MOLD

(71) Applicants: Chien-Wei Chen, New Taipei City (TW); Ching-Fu Hsu, New Taipei City (TW)

(72) Inventors: Chien-Wei Chen, New Taipei City (TW); Ching-Fu Hsu, New Taipei City (TW)

(73) Assignee: WISTRON CORPORATION, New Taipei City (TW)

(21) Appl. No.: 13/477,045

(22) Filed: May 21, 2012

(30) Foreign Application Priority Data
Nov. 29, 2011 (TW) 100143738

(51) Int. Cl. B29C 59/02

(52) U.S. Cl. 264/293; 425/385

(57) ABSTRACT

An embossing method is provided. The embossing method includes the following steps. A three-dimensional workpiece and a soft stamp are configured in a chamber. A non-cured material layer is configured on a decoration surface of the three-dimensional workpiece. The decoration surface is not a plane. The soft stamp is configured on the non-cured material layer, and a surface of the soft stamp contacting the non-cured material layer has an embossing pattern. A high pressure gas is injected into the chamber, so as to press the soft stamp and transfer the embossing pattern to the non-cured material layer. The non-cured material layer with the transferred embossing pattern is cured to form a cured material layer. In addition, an embossing mold is also provided.

### CROSS-REFERENCE TO RELATED APPLICATION

This application claims the priority benefit of Taiwan application serial no. 100143738, filed on Nov. 29, 2011. The entirety of the above-mentioned patent application is hereby incorporated by reference herein and made a part of this specification.

### BACKGROUND OF THE INVENTION

1. Field of the Invention

The present invention generally relates to an embossing method and an embossing method, in particular, to an embossing method and an embossing mold for transfer pattern to a three-dimensional workpiece.

2. Description of Related Art

A micro-hot embossing method is a main micro-structure replication technology in the field of Micro-ElectroMechanical Systems (MEMS), in which the micro-structure refers to a structure having a micrometer or nano-meter size. The micro-structure may be directly used as a component or may be utilized through other manufacturing processes. The manufacturing process is simple and manufacturing in batches may be performed, so that if shaping precision and quality of finished products may be effectively controlled, production capacity of MEMS products may be improved.

FIG. 1A to FIG. 1D are schematic views of a conventional embossing technology. Referring to FIG. 1A, for the recent embossing technology, a non-cured layer 120 is coated on a flat-panel 110. Next, referring to FIG. 1B, an embossing pattern is transferred to the non-cured layer 120 by an embossing mold 130. Next, the non-cured layer 120 is cured to form a cured layer 140. Further, referring to FIG. 1C, the embossing mold 130 is separated from the flat-panel 110 with the cured layer 140. Finally, referring to FIG. 1D, a three-dimensional shaping action is performed on the flat-panel 110 with the cured layer 140.

However, when the three-dimensional shaping action is performed, the embossing pattern embossed on the flat-panel 110 is easily deformed and broken because of stretching and squeezing after being stressed by forces. Particularly, the situation is more serious when an angle at a corner position 102 is particularly small.

### SUMMARY OF THE INVENTION

Accordingly, the present invention is directed to an embossing method, capable of solving a problem that when being three-dimensionally shaped, an embossing pattern embossed on a workpiece is damaged after being stressed by forces.

The present invention is further directed to an embossing mold, capable of preventing an embossing pattern embossed on a workpiece from being damaged.

One aspect of the present invention provides an embossing method, which includes the following steps. A three-dimensional workpiece and a soft stamp are configured in a chamber, in which a non-cured material layer is configured on a decoration surface of the three-dimensional workpiece, the decoration surface is not a plane, the soft stamp is configured on the non-cured material layer, and a surface of the soft stamp contacting the non-cured material layer has an embossing pattern. A high pressure gas is injected into the chamber, so as to press the soft stamp and transfer the embossing pattern to the non-cured material layer. The non-cured material layer with the transferred embossing pattern is cured to form a cured material layer.

Another aspect of the present invention provides an embossing mold, which includes an upper mold and a lower mold. The upper mold has a clamping portion and a gas inlet, in which the clamping portion is used to clamp a soft stamp. The lower mold has a carrying platform, in which the carrying platform is used to carry a three-dimensional workpiece, the lower mold is used to be combined with the upper mold, and the gas inlet is used to introduce air to press the soft stamp to be closely and perfectly adhered to the three-dimensional workpiece.

In order to make the aforementioned features and advantages of the present invention comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A to FIG. 1D are schematic views of a conventional embossing technology.

FIG. 2 is a text flow chart of an embossing method according to an embodiment of the present invention.

FIG. 3A to FIG. 3E are entity flow charts of performing embossing on a three-dimensional workpiece in the embossing method of FIG. 2.

FIG. 4A to FIG. 4C are schematic flow charts of manufacturing a soft stamp in the embossing method of FIG. 2.

FIG. 5 is a schematic flow chart of curing a non-cured material layer in an embossing method according to another embodiment of the present invention.

FIG. 6A to FIG. 6E are schematic flow charts of performing embossing on a three-dimensional workpiece in an embossing method according to further another embodiment of the present invention.

FIG. 7 is a three-dimensional view of an embossing mold according to an embodiment of the present invention.

FIG. 8 is a cross-sectional view of the embossing mold of FIG. 7.

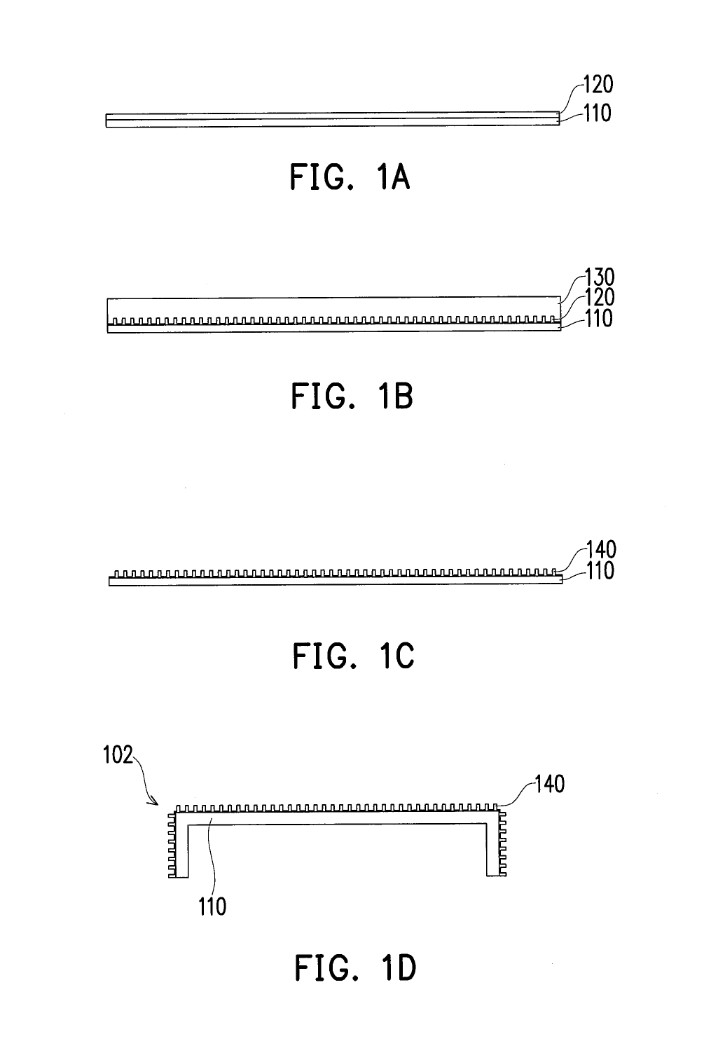

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

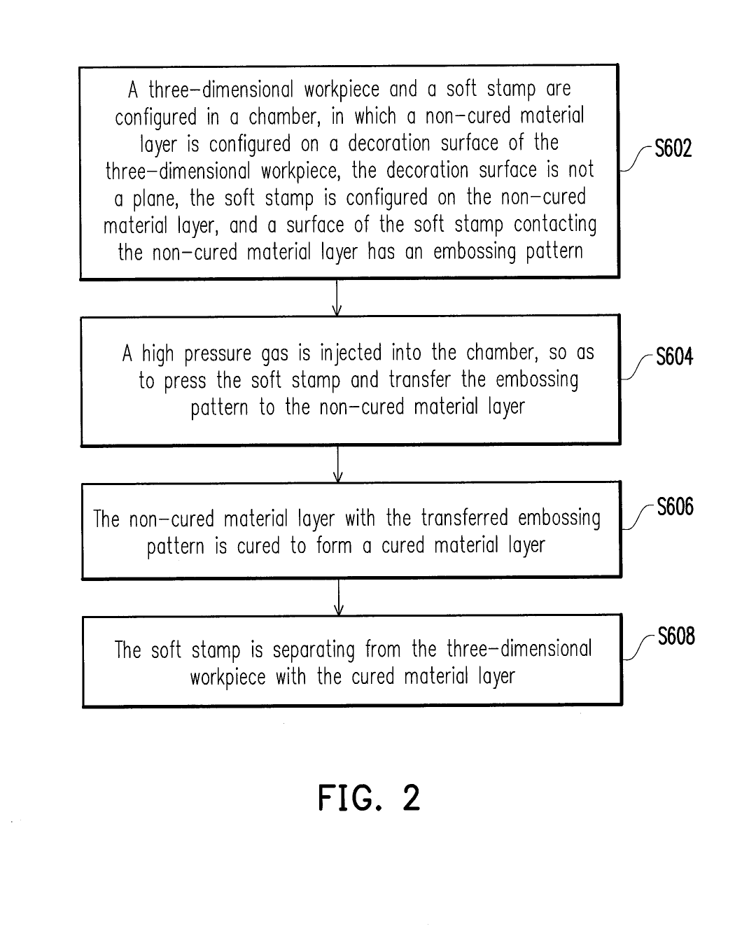

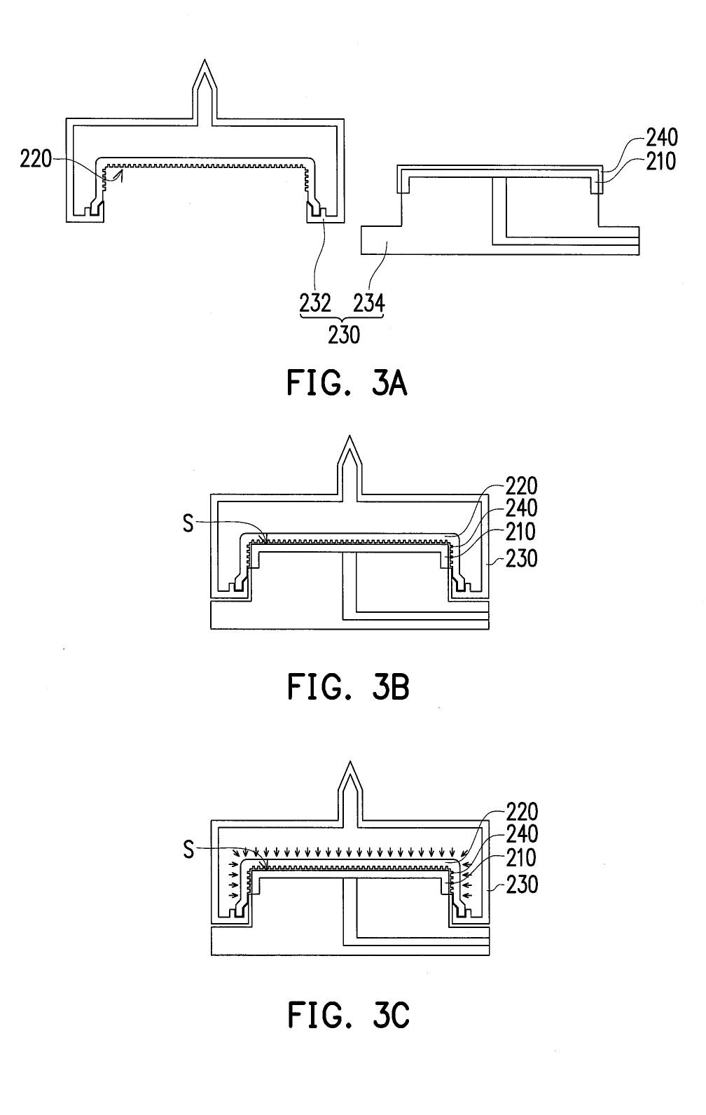

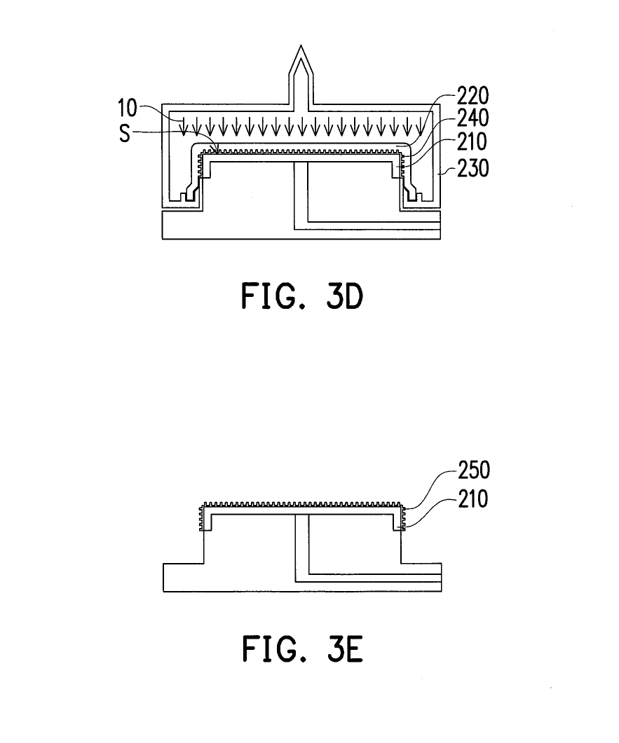

FIG. 2 is a text flow chart of an embossing method according to an embodiment of the present invention, and FIG. 3A to FIG. 3E are entity flow charts of performing embossing on a three-dimensional workpiece in the embossing method of FIG. 2. Referring to FIG. 2 and FIG. 3B, in the embossing method of this embodiment, a three-dimensional workpiece 210 and a soft stamp 220 are configured in a chamber 230. Here, a non-cured material layer 240 is configured on a decoration surface S of the three-dimensional workpiece 210. It should be noted that the decoration surface S is not a plane. In other words, before embossing is performed, the three-dimensional workpiece 210 is already shaped to a final appearance. The soft stamp 220 is configured on the non-cured material layer 240, and a surface of the soft stamp 220 contacting the non-cured material layer 240 has an embossing pattern (Step S602).

Next, referring to FIG. 2 and FIG. 3C, a high pressure gas is injected into the chamber 230, so as to press the soft stamp 220 and transfer the embossing pattern to the non-cured material layer 240 (Step S604).

Further, referring to FIG. 2 and FIG. 3D, after the high pressure gas is injected into the chamber 230, the non-cured material layer 240 with the transferred embossing pattern is cured to form a cured material layer 250 (Step S606).

Under the process, in the embossing method of the present invention, the three-dimensional workpiece 210 is shaped in advance, and next, subsequent pressing transferring and curing actions are performed on the three-dimensional workpiece 210 through the soft stamp 220 with the embossing pattern (Step S604 and Step S606), so as to finish fabricating the three-dimensional workpiece 210. In other words, after the pressing transferring and the curing actions are performed on the three-dimensional workpiece 210, a three-dimensional shaping action is not performed on the three-dimensional workpiece 210, so as to prevent the embossing pattern on the three-dimensional workpiece 210 from being damaged because of stretching and squeezing after being stressed by forces.

In addition, referring to FIG. 2 and FIG. 3A, the chamber 230 is formed by an upper stamp tool 232 and a lower stamp tool 234. Before Step S602, firstly the soft stamp 220 is configured in the upper stamp tool 232, the three-dimensional workpiece 210 is configured in the lower stamp tool 234, and a non-cured material layer 240 is configured on the three-dimensional workpiece 210. Next, the upper stamp tool 232 is combined with the lower stamp tool 234, so as to form the complete chamber 230. However, in this embodiment, the manner in which the three-dimensional workpiece 210 and the soft stamp 220 are configured in the chamber 230 is not limited. In other embodiments, the three-dimensional workpiece 210 may be firstly configured in the lower stamp tool 234, then the soft stamp 220 is configured on the three-dimensional workpiece 210, and then the upper stamp tool 232 is combined with the lower stamp tool 234.

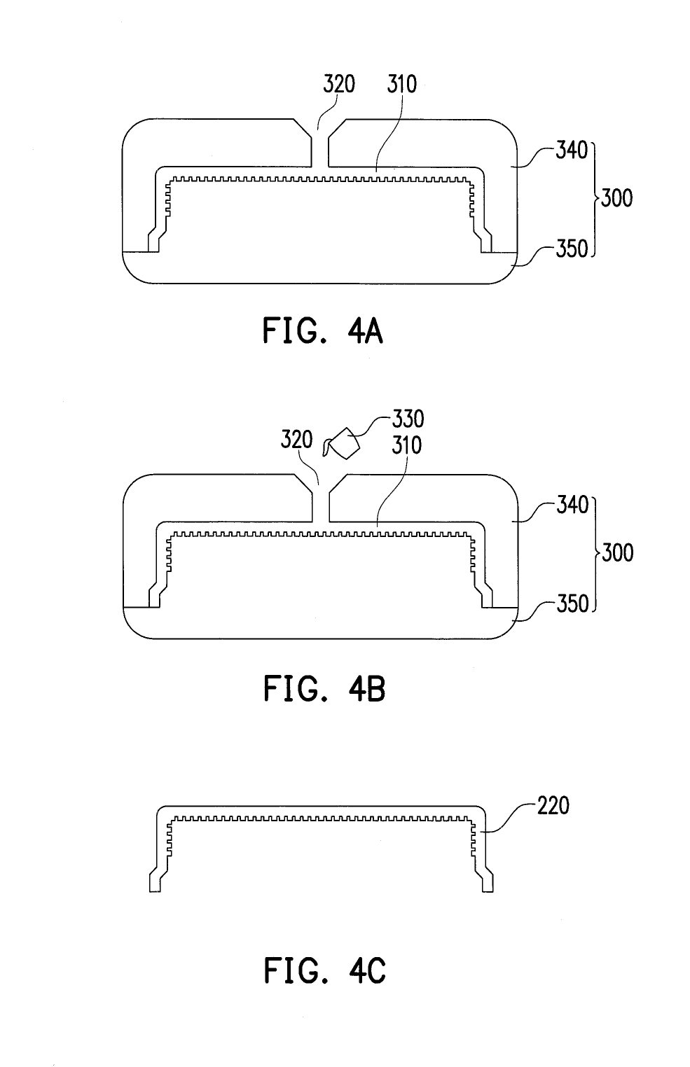

In the following, an example is given to describe a fabrication process of the soft stamp 220. FIG. 4A to FIG. 4C are schematic flow charts of manufacturing a soft stamp in the embossing method of FIG. 2. Referring to FIG. 4A, in this embodiment, firstly, a mold 300 is provided. The mold 300 has a cavity 310 and a hot runner 320. An embossing pattern is formed on an inner wall of the cavity 310. Next, a soft material 330 is injected into the cavity 310 from the hot runner 320, and cavity 310 is filled up with the soft material 330 (as shown in FIG. 4B). It should be noted that the soft material 330 is manufactured by using a high molecular material, for example, polydimethylsiloxane (PDMS), silicone, or polyurethane (PU). Afterwards, the mold 300 is cooled, and the soft stamp 220 with the embossing pattern is cured and shaped in the cavity 310. Finally, an upper mold set 340 and a lower mold set 350 of the mold 300 are separated from each other, so as to take out the shaped soft stamp 220 (as shown in FIG. 4C).

In detail, the soft stamp 220 of this embodiment is a three-dimensional soft stamp. It should be noted that when the three-dimensional workpiece 210 and the soft stamp 220 are just configured in the chamber 230, the soft stamp 220 is perfectly adhered to the non-cured material layer 240. That is to say, the soft stamp 220 is the three-dimensional soft stamp and has a shape matching the three-dimensional workpiece 210, so that the soft stamp 220 may be perfectly adhered to the decoration surface S being not the plane. The three-dimensional workpiece 210 is shaped in advance, so that after the subsequent embossing and the curing actions are performed on the decoration surface S being not the plane, the shaping step is not performed on the three-dimensional workpiece 210.

In another aspect, in Step S606, a method for curing the non-cured material layer 240 includes irradiating an ultra-violet ray on the non-cured material layer 240 with the transferred embossing pattern. That is to say, in Step S630, for example, an ultra-violet ray light source 10 is provided from the upper stamp tool 232 or other positions, so that a light ray of the ultra-violet ray light source 10 penetrates the soft stamp 220 to be irradiated on the non-cured material layer 240, so as to polymerize and cure the non-cured material layer 240. Here, the non-cured material layer 240 is cured through irradiation of the ultra-violet ray light source 10, so that the soft stamp 220 needs to have a light transmissive material, for facilitating the action of irradiating the ultra-violet ray light source 10.

In addition, referring to FIG. 2 and FIG. 3E, after Step S606, the embossing method further includes separating the soft stamp 220 from the three-dimensional workpiece 210 with the cured material layer 250 (Step S608). That is to say, after cured material layer 250 is formed, the upper stamp tool 232 is separated from the lower stamp tool 234, so as to take out the three-dimensional workpiece 210 with the cured material layer 250.

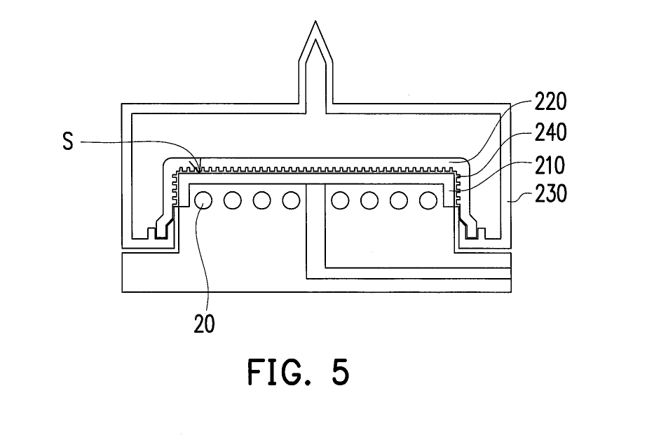

FIG. 5 is a schematic flow chart of curing a non-cured material layer in an embossing method according to another embodiment of the present invention. Referring to FIG. 5, the embossing method of this embodiment is approximately the same as the embodiment of FIG. 3D, in which similar elements adopt the same numerals, except that the method for curing the non-cured material layer 240 in this embodiment is heating the non-cured material layer 240 with the transferred embossing pattern. For example, the lower stamp tool 234 may provide a heating device 20, used to increase temperature of the three-dimensional workpiece 210, in which the non-cured material layer 240 is located on a surface of the lower stamp tool 234, so that through a thermal conduction manner, the non-cured material layer 240 may also be heated, so as to be cured.

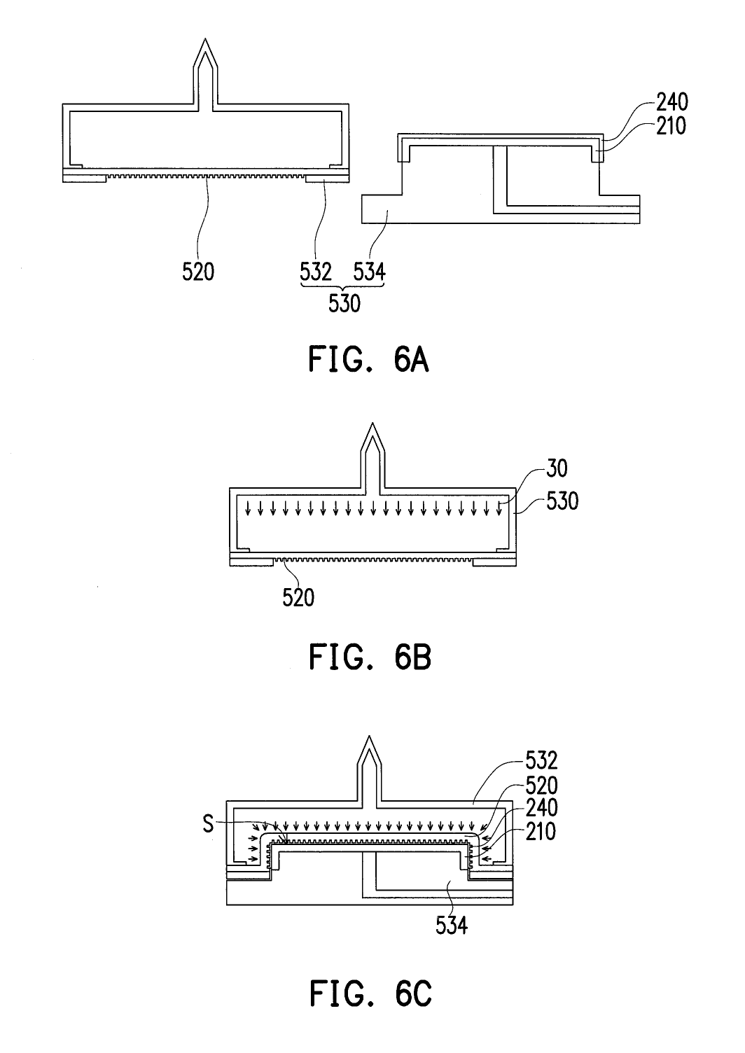

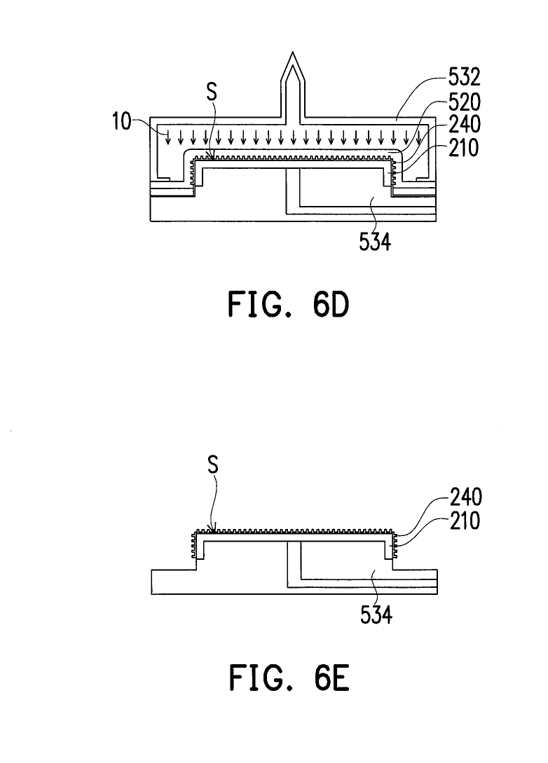

FIG. 6A to FIG. 6E are schematic flow charts of performing embossing on a three-dimensional workpiece in an embossing method according to further another embodiment of the present invention, in which the elements similar to that of the above embodiment adopt the same numerals. Referring to FIG. 2 and FIG. 6A to FIG. 6E, in this embodiment, a soft stamp 520 is a plane film instead of being a three-dimensional soft stamp. The film 520 of this embodiment may be the plane film manufactured by using plastics, for example, polycarbonate (PC), polyethylene terephthalate (PET), or polyvinylchloride (PV). Further, after the film 520 is configured in a chamber 530 and before a high pressure gas is injected, the embossing method of this embodiment further includes softening the film 520.

Further, a method for softening the film 520 may be irradiating an infrared ray on the film 520. That is to say, before Step S604, for example, an infrared ray light source 30 is provided from an upper stamp tool 532, and the infrared ray light source 30 is used to heat the film 520 to soften the film 520, so that the film 520 may be perfectly adhered to the non-cured material layer 240. In another aspect, in Step S606, definitely, a method for curing the non-cured material layer 240 may also be irradiating an ultra-violet ray, heating, or other manners, and here, only the schematic view of the manner of using the ultra-violet ray light source 10 is shown and description is not repeated.

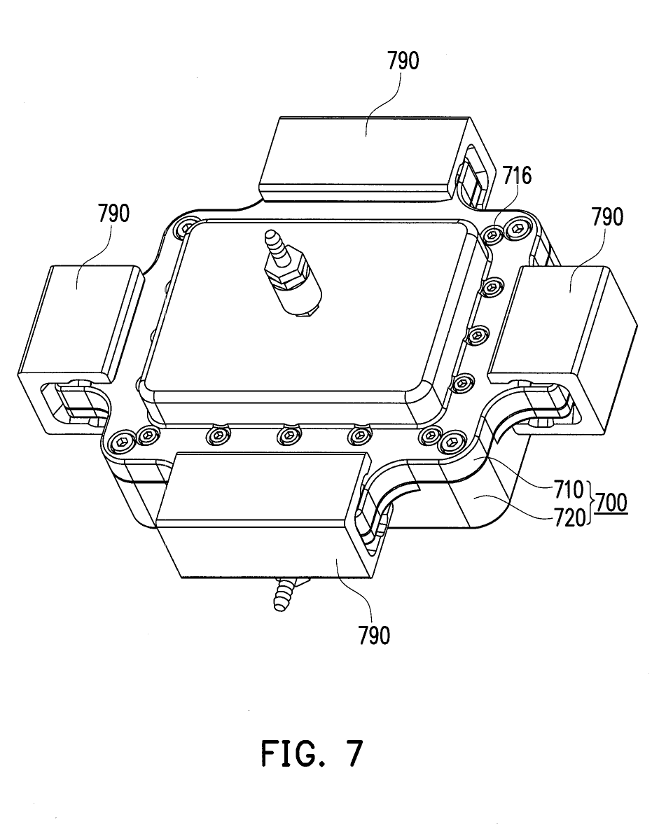

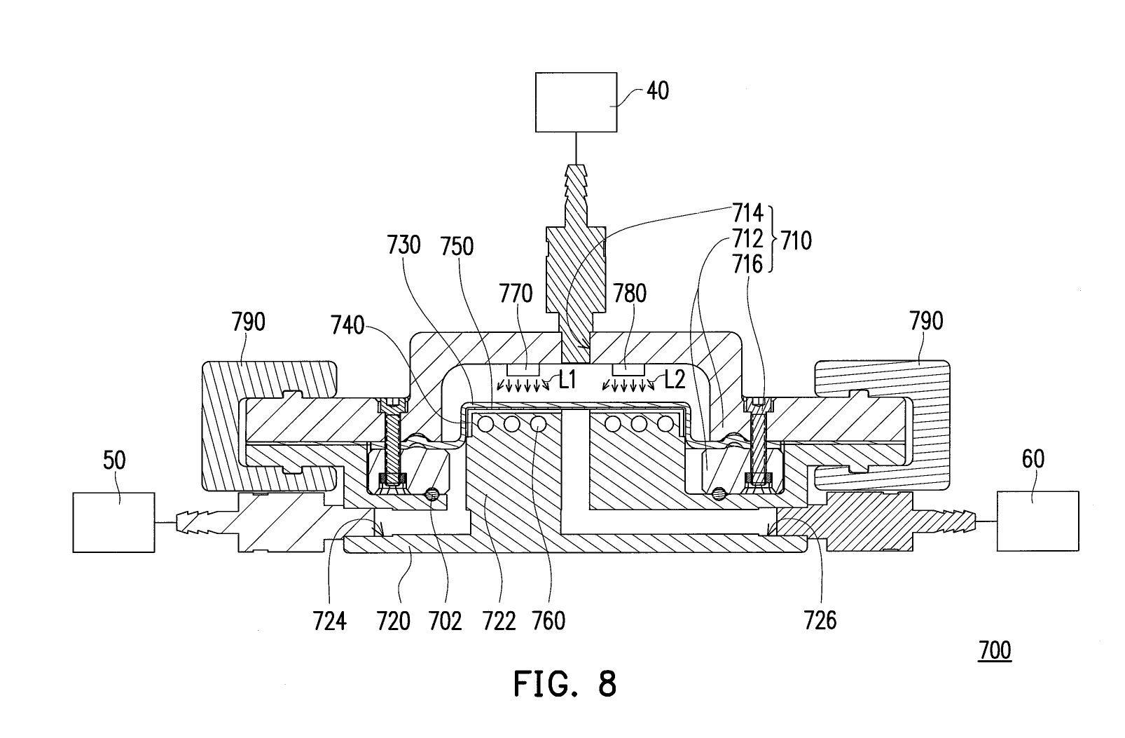

FIG. 7 is a three-dimensional view of an embossing mold according to an embodiment of the present invention, and FIG. 8 is a cross-sectional view of the embossing mold of FIG. 7. In this embodiment, the embossing mold 700 may be used to execute the embossing method. Referring to FIG. 7 and FIG. 8, the embossing mold 700 includes an upper mold 710 and a lower mold 720, and the lower mold 720 is used to be combined with the upper mold 710. The upper mold 710 has a clamping portion 712 and a gas inlet 714. The clamping portion 712 is used to clamp a soft stamp 730, and the clamping portion 712 may be locked by a locking part 716 to fix the soft stamp 730. The lower mold 720 has a carrying platform 722, and the carrying platform 722 is used to carry a three-dimensional workpiece 740. A non-cured material layer 750 is configured on the three-dimensional workpiece 740. The soft stamp 730 is configured on the non-cured material layer 750, and a surface of the soft stamp 730 contacting the non-cured material layer 750 has an embossing pattern.

Accordingly, the gas inlet 714 is used to introduce air, so as to press the soft stamp 730 to be closely perfectly adhered to the three-dimensional workpiece 740. In detail, in this embodiment, the air may be introduced into the embossing mold 700 through an air pump 40, so as to press the soft stamp 730 and transfer the embossing pattern to the non-cured material layer 750.

Further, here, the non-cured material layer 750 is not cured, so that a shape of the embossing pattern of the non-cured material layer 750 is not fixed. When the non-cured material layer 750 selects a thermosetting material, the embossing mold 700 may include a heating device 760 (for example, a heat coil), the heating device 760 is disposed on the lower mold 720 and is suitable for increasing temperature of the lower mold 720, and through a thermal conduction manner, the non-cured material layer 750 on the three-dimensional workpiece 740 is heated, so as to be cured.

In another aspect, if the non-cured material layer 750 selects an ultra-violet curing material, the embossing mold 700 may include an ultra-violet ray light source 770. The ultra-violet ray light source 770 is disposed under the upper mold 710 and is suitable for providing an ultra-violet ray L1, so that the ultra-violet ray L1 penetrates the soft stamp 730 to be irradiated on the non-cured material layer 750, so as to cure the non-cured material layer 750.

In addition, according to the embossing method, the soft stamp 730 may be a three-dimensional soft stamp or a plane soft stamp. When the soft stamp 730 is the plane soft stamp, the embossing mold 700 may further include an infrared ray light source 780. The infrared ray light source 780 may be disposed on the upper mold 710 and is suitable for providing an infrared ray L2, the infrared ray L2 heats the soft stamp 730 to soften the soft stamp 730, so that the soft stamp 730 is perfectly adhered to the non-cured material layer 750.

In this embodiment, the embossing mold 700 further includes a gas seal ring 702. The gas seal ring 702 is configured on a combination surface of the lower mold 720 and the upper mold 710, so as to prevent gas from running out from the combination surface of the lower mold 720 and the upper mold 710.

In this embodiment, the lower mold 720 further has a gas extracting port 724. The gas extracting port 724 communicates with a space between the soft stamp 730 and the lower mold 720 after the lower mold 720 is combined with the upper mold 710. Therefore, an air-extractor 50 is used to perform a vacuum-pumping action on the space between the soft stamp 730 and the lower mold 720 from the gas extracting port 724, so that the space between the soft stamp 730 and the lower mold 720 keeps a vacuum state, so that during the step of transferring the embossing pattern to the non-cured material layer 750, bubbles exist between the soft stamp 730 and the non-cured material layer 750.

In another aspect, the lower mold 720 further has a gas extracting port 726. The gas extracting port 726 communicates with a surface of the carrying platform 722. In this embodiment, an air-extractor 60 is used to perform a vacuum-pumping action from the gas extracting port 726, so that the three-dimensional workpiece 740 is absorbed and fixed on the surface of the carrying platform 722.

In addition, the embossing mold 700 further includes a plurality of C-shaped clips 790, used to tightly clip the lower mold 720 and the upper mold 710.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An embossing method, comprising:
configuring a three-dimensional workpiece and a soft stamp in a chamber, wherein a non-cured material layer is configured on a decoration surface of the three-dimensional workpiece, the decoration surface is not a plane, the soft stamp is configured on the non-cured material layer, and a surface of the soft stamp contacting the non-cured material layer comprises an embossing pattern;
injecting a high pressure gas into the chamber, so as to press the soft stamp and transfer the embossing pattern to the non-cured material layer; and
curing the non-cured material layer with the transferred embossing pattern to form a cured material layer.

2. The embossing method according to claim 1, wherein the soft stamp is a three-dimensional soft stamp, and when the three-dimensional workpiece and the soft stamp are just configured in the chamber, the soft stamp is adhered to the non-cured material layer.

3. The embossing method according to claim 1, wherein the soft stamp is a plane film, and after the soft stamp is configured in the chamber and before the high pressure gas is injected, the method further comprises softening the plane film to enable the plane film to be perfectly adhered to the non-cured material layer.

4. The embossing method according to claim 3, wherein a method for softening the plane film comprises irradiating an infrared ray on the plane film.

5. The embossing method according to claim 1, wherein a method for curing the non-cured material layer comprises irradiating an ultra-violet ray on the non-cured material layer with the transferred embossing pattern.

6. The embossing method according to claim 1, wherein a method for curing the non-cured material layer comprises heating the non-cured material layer with the transferred embossing pattern.

7. The embossing method according to claim 1, further comprising separating the soft stamp from the three-dimensional workpiece with the cured material layer.

8. An embossing mold, comprising:
an upper mold, comprising a clamping portion and a gas inlet, wherein the clamping portion is used to clamp a soft stamp; and
a lower mold, comprising a carrying platform, wherein the carrying platform is used to carry a three-dimensional workpiece, the lower mold is used to be combined with the upper mold, the gas inlet is used to introduce air to press the soft stamp to be closely and perfectly adhered to the three-dimensional workpiece.

9. The embossing mold according to claim 8, further comprising a gas seal ring, configured on a combination surface of the lower mold and the upper mold.

10. The embossing mold according to claim 8, wherein the lower mold further comprises a gas extracting port, communicating with a space between the soft stamp and the lower mold after the lower mold is combined with the upper mold.

11. The embossing mold according to claim 8, wherein the lower mold further comprises a gas extracting port, communicating with a surface of the carrying platform.

12. The embossing mold according to claim 8, further comprising a plurality of C-shaped clips, used to tightly clip the lower mold and the upper mold.
